(19) United States
(12) Patent Application Publication
(10) Pub. No.: US 2026/0268392 A1
(43) Pub. Date: Sep. 10, 2026

(54) System and Method for an Immersive Marketplace with Interactive Visualization of Retail Items in a User Space

(71) Applicants: Travis Carona, Cedar Park, TX (US); Kate Ritter, Austin, TX (US)

(72) Inventors: Travis Carona, Cedar Park, TX (US); Kate Ritter, Austin, TX (US)

(73) Assignee: Homekynd Holdings Inc., Austin, TX (US)

(21) Appl. No.: 19/559,667

(22) Filed: Mar. 6, 2026

Related U.S. Application Data
(60) Provisional application No. 63/768,863, filed on Mar. 7, 2025.

(51) Int. Cl. G06Q 30/0601

(52) U.S. Cl. CPC G06Q 30/06433

(57) ABSTRACT

A system and method is provided for interactively visualizing retail items for sale from different manufacturers within a virtual 3D representation or digital twin of a user space, thereby providing a photorealistic “try-before-you-buy” experience. In one embodiment, the host generates a 3D digital twin from a 2D photo or image of a user space. The user is then allowed to place and manipulate (position, scale, rotate, etc.) retail items (or 3D models thereof) within the digital twin. These items may be placed within an empty (decluttered) digital twin or together with items that were originally depicted within the digital place, with those items being 3D modeled for manipulation. The user can then participate in a unified checkout process where a single purchase on the host website effectuates multiple purchases (purchasing multiple items) from multiple merchants.

### BACKGROUND OF THE INVENTION

### 1 Field of the Invention

The present invention relates to a system and method for interactively visualizing at least one retail item for sale from at least one merchant within a three-dimensional (“3D”) visual representation of a user-provided space.

### 2. Description of Related Art

Many current marketplaces (e.g., Amazon, Wayfair, etc.) provide an online catalogue experience, with visualization provided as photo assets. Existing methods for visualizing photos of online items in a user's space are limited. Virtual viewing options are at best one item at a time, one merchant at a time, and involve 2D static layers of products on 2D static background images. However, static images or videos fail to capture the interactive nature of product placement and assessment within a specific environment, and physical demonstrations are costly and inconvenient. Other tools may use 3D environments but will create a fully synthetic environment where the user's furniture or items are not able to be manipulated.

This invention addresses these limitations by using (or creating) a three-dimensional (“3D”) representation of the user's assets, persons, and/or home spaces (“digital twin”) to create an interactive, immersive experience, where the user can shop by viewing items for sale within (or together with) their digital twin. An innovation of the present invention lies in the ability to simultaneously visualize multiple retail items from multiple retailers within (or together with) their digital twin (e.g., in their living room, next to their existing chair, etc.). In one embodiment, the visualization engine composites 3D rendered elements over the user's original 2D room photograph rather than generating a fully synthetic scene, where the user's photograph persists as the background layer. 3D models of retail and user items are rendered with physical-based lighting and shadow calculations relative to the room geometry. A floor geometry mask allows shadows cast by 3D models to appear to fall on the photographic floor surface, creating a seamless integration between the photographic background and the placed 3D object. This approach preserves the authenticity of the user's actual environment while enabling 3D placement. This contrasts with existing technologies that typically limit visualization of static 2D representations of a single item in isolation or 3D items that cannot be manipulated alongside user's own inventory of items. The interactive nature of the system allows users to assetize their entire space by inventorying and creating 3D assets, manipulate user item placement, and view the results in real-time along with the item(s) for sale being visualized. This “try-before-you-buy” capability bridges the gap between simplistic online and costly (and time consuming) offline shopping experiences.

### SUMMARY OF THE INVENTION

The present invention provides a system and method for interactive visualization of retail items for sale from different manufacturers within (or together with) a virtual three-dimensional (3D) representation (or digital twin) of a user's own assets, home, commercial, or other spaces, and/or person. This virtual placement and manipulation is provided using a many-to-many relationship, allowing the user to select between multiple products from multiple brands and/or manufactures simultaneously, providing a photorealistic “try-before-you-buy” experience.

In a preferred embodiment, the present invention operates over a wide area network (“WAN”), such as the internet, where a host device is in communication with at least one user device and a plurality of merchants via the WAN. In one embodiment, the host device includes at least a web server, at least one application, and a database, which operate together to interactively visualize at least one retail item for sale from at least one merchant within a 3D visual representation (or digital twin) of a user space.

In one embodiment, an application operating on the host device is configured to generate a 3D visual representation (or digital twin) of a user space (e.g., living room, office, backyard, etc.) from a 2D photo or image provided by the user of a user space. In other embodiments, the 3D digital twin is provided to or imported by the host (e.g., from the user, from the host's database, etc.). Once a digital twin is available (e.g., generated, imported, etc.), the application allows the user to virtually place and manipulate retail items within (or together with) their digital twin. The application may further provide intuitive controls for positioning, scaling, rotating, and shopping for items. In one embodiment, the application is not only used to generate or import the digital twin but to place virtually retail items that are being offered for sale by merchants in a realistic and interactive manner for a final display image output.

In one embodiment of the present invention, the digital twin may be analyzed to determine if there are items located within the room (or space). If there are, then a 3D digital model of each item can be created. These items can then be removed from the digital twin (e.g., decluttering the room) or remain, depending on user preferences. For items that are to be removed, a “decluttering” algorithm is used to remove these items from the digital twin. For items that should remain, a 3D representation (or model) of the item may be created, and the user may be allowed to interact with them within the 3D digital twin (e.g., rotate them, move them to another location, etc.).

Once a digital twin is decluttered or models created, the user can then shop and select items that are for sale from various merchants. In some instances, the host has previously received information about certain items (e.g., images, prices, options, etc.) and created 3D models of the items. This information and/or models may be stored in the host's database. In other instances, such information is retrieved (in real time) and digital models created (again, in real time). Either way individual items can be selectively displayed within (or together with) the digital twin. These merchant items can be displayed together with or separate from items originally depicted in the user's space (e.g., as modeled). Either way, the items (both user and merchant) and the digital twin are interactive (e.g., the user can move the items to different locations within the space, rotate the items within the space, change their perspective with respect to an item and/or within the space, etc.). The merchant items may also be shown in a preview pane where they can be selected for purchase. The user can then use a unified checkout system that allows for a single purchase from the host to effectuate multiple purchases (i.e., purchase multiple items) from multiple merchants.

A more complete understanding of a system and method for interactive visualization of retail items in a 3D user space, including additional processes for preferred and certain embodiments, will be afforded to those skilled in the art, as well as a realization of additional advantages and objects thereof, by a consideration of the following detailed description of the present invention. Reference will be made to the appended sheets of drawings, which will first be described briefly.

### BRIEF DESCRIPTION OF THE DRAWINGS

FIG. 1 illustrates an environment in which the present invention may operate wherein a user device interacts with a host device via a wide area network (“WAN”), such as the Internet, the host device further being in communication with a plurality of merchants via said WAN;

FIG. 2 illustrates the creation of a 3D visual representation (“digital twin”) of a user space from a user-provided 2D photo (or image) of said space in accordance with one embodiment of the present invention;

FIGS. 3A-D illustrate how the digital twin (FIG. 3A) can be processed and/or modified to declutter the digital twin (FIG. 3B), digitally model items depicted within the digital twin (FIG. 3C), and/or stage items for sale from merchants (or models thereof) within the digital twin (FIG. 3D) in accordance with one embodiment of the present invention;

FIGS. 4A-B further illustrate how an application depicted in FIG. 1 can be used to segment items depicted within the digital twin, allowing the digital twin to not only be decluttered but to create 3D models of items depicted therein in accordance with one embodiment of the present invention;

FIG. 5 illustrates how items for sale can be selected (e.g., automatically, by the user, etc.), modeled, and depicted within the digital twin, thereby providing a “try-before-you-buy” experience of the present invention;

FIG. 6 illustrates a unified checkout system in accordance with one embodiment of the present invention where a user can purchase items from multiple merchants via a single checkout process on the host's website;

FIG. 7a illustrates a method of visualizing at least one retail item for sale from at least one merchant within a 3D visual representation of the same, or digital twin, in accordance with one embodiment of the present invention; and FIG. 7b illustrates a simplified method of purchasing items from a plurality of merchants using the unified checkout interface depicted in FIG. 6.

### DETAILED DESCRIPTION OF THE PRESENT INVENTION

Disclosed herein is a system and method for interactive visualization of retail items for sale from different manufacturers and/or merchants within (or together with) a virtually three-dimensional (3D) representation (or “digital twin”) of a user's own assets, home, commercial, or other spaces, and/or person. This virtual placement and manipulation is provided using a many-to-many relationship, allowing the user to select between multiple products from multiple brands and/or manufacturers simultaneously, providing a photorealistic “try-before-you-buy” experience. This enhances purchasing decisions, increases buyer confidence, and bridges the gap between online and offline shopping, benefiting both consumers and retailers.

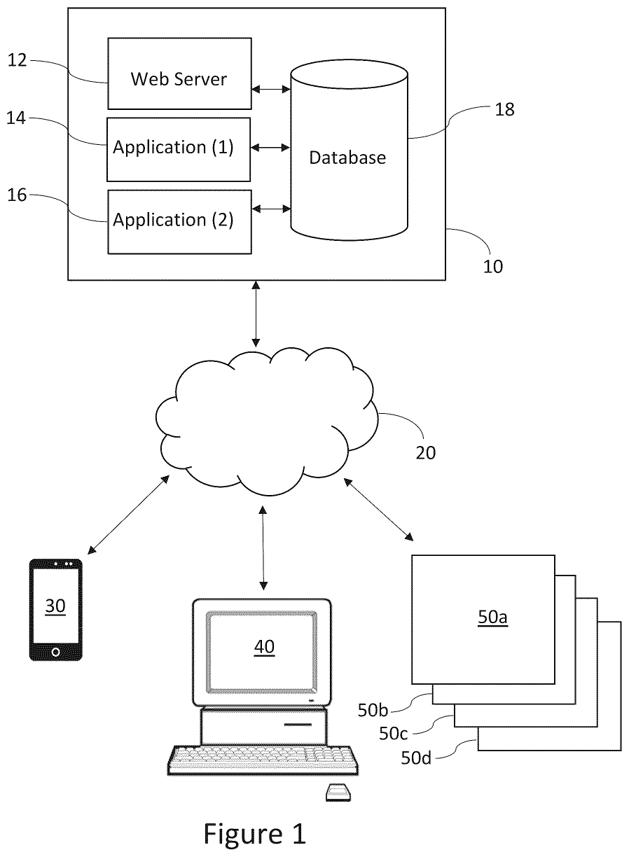

As shown in FIG. 1, the present invention may operate over a wide area network (“WAN”) 20, such as the internet, where a host device 10 is in communication with at least one user device (30, 40) and a plurality of merchants (50a, b, c, d) via the WAN. In one embodiment, the host device includes at least a web server 32, at least one application (14, 16) and a database 18, which operate together to interactively visualize at least one retail item for sale from at least one merchant within a 3D visual representation (“digital twin”) of a user space.

It should be appreciated that present invention is not limited to the system illustrated in FIG. 1 and may include different, additional, and/or fewer components and/or provide different, additional, and/or fewer functions. For example, the host device 10 may further be in communication with a plurality of financial institutions via said WAN (e.g., for user subscription fees, item purchases, etc.). By way of another example, the host device 10 may include different, additional, and/or fewer applications, depending on how the system is designed. For example, a system that includes a 2D to 3D transformation application, a virtual space marketplace application, an interactive placement application, a decluttering application, and/or a unified checkout application, individually or combined, is within the spirit and scope of the present invention.

It is not so important as to the nature and makeup of each device but how the devices function together (or communicate with one another) over the WAN to achieve the foregoing benefits and improvements, including (1) generating a digital twin, (2) interfacing with multiple merchant databases, (3) enabling interactive item placement, and ultimately (4) providing a secure and user-friendly shopping and checkout experience. With that said, it should also be appreciated that the present invention does not require a user purchase and use of the system to merely browse for items that are for sale by the merchants and/or rearrange items currently owned by the user (e.g., items depicted within the user space, photos (or images) of items provided by the user, etc.) is within the spirit and scope of the present invention. It should also be appreciated that the term “3D” is used herein to indicate depth and/or provide an immersive and/or interactive experience. For example, a user may be able to change their viewing perspective (e.g., left, right, forward, back) within the 3D digital twin and/or a user may be able to move and rotate 3D models within the digital twin.

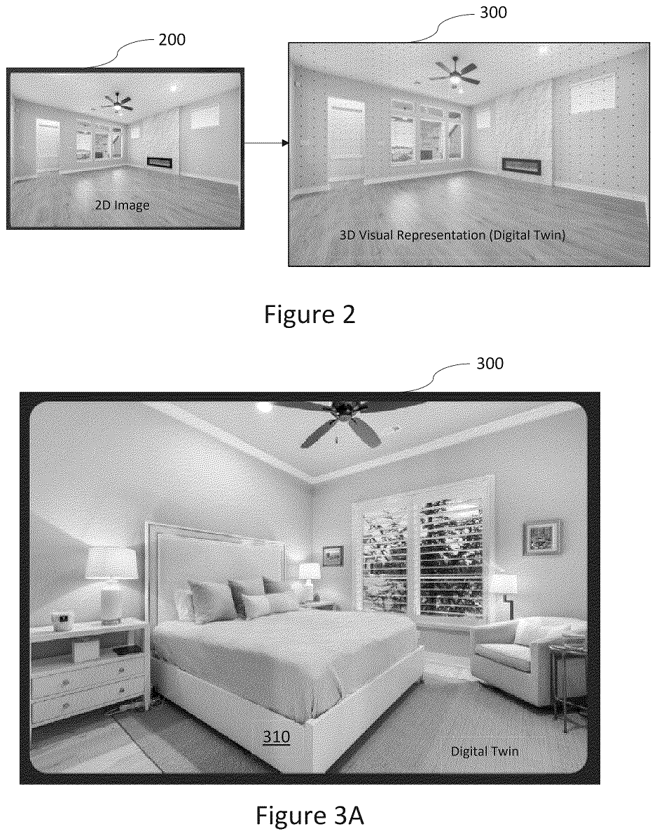

As shown in FIG. 2, the system is preferably configured to generate a 3D visual representation 300 (or digital twin) of a user space (e.g., living room, office, backyard, etc.) from a 2D photo or image 200 provided by the user. In other embodiments, the digital twin is provided to or imported by the host (e.g., from the user, as stored in its database, etc.). This may involve various techniques, including but not limited to, user-provided measurements, photographic input, or 3D scanning. As discussed in greater detail below, the database (see, e.g., FIG. 1 at 18) may contain 3D models of retail items, including relevant metadata, which may include but is not limited to dimensions, textures, product type tagging, style type, color, material, and other visual attributes. These items and/or information may be stored locally, or imported (e.g., in real-time) from a merchant's website.

Once a digital twin is available (e.g., generated, imported, etc.), the application (see, e.g., FIG. 1 at 14 and/or 16) allows the user to virtually place and manipulate retail items within (or together with) their digital twin. The application may provide intuitive controls for positioning, scaling, rotating, and shopping for items. In one embodiment, the application is not only used to generate or import the digital twin (which can include not only spaces but items that are currently within the space) but to place virtually retail items that are being offered for sale by merchants in a realistic and interactive manner for a final display image output.

In one embodiment, as discussed in greater detail below, the system should also include a user-friendly interface that allows users to easily navigate the digital twin(s), select retail items, manipulate their placement, and, if desired purchase the same for deliver or pickup. Again, it should be appreciated that the system is modular and may include fewer or additional components for performing fewer, additional, and/or different functions.

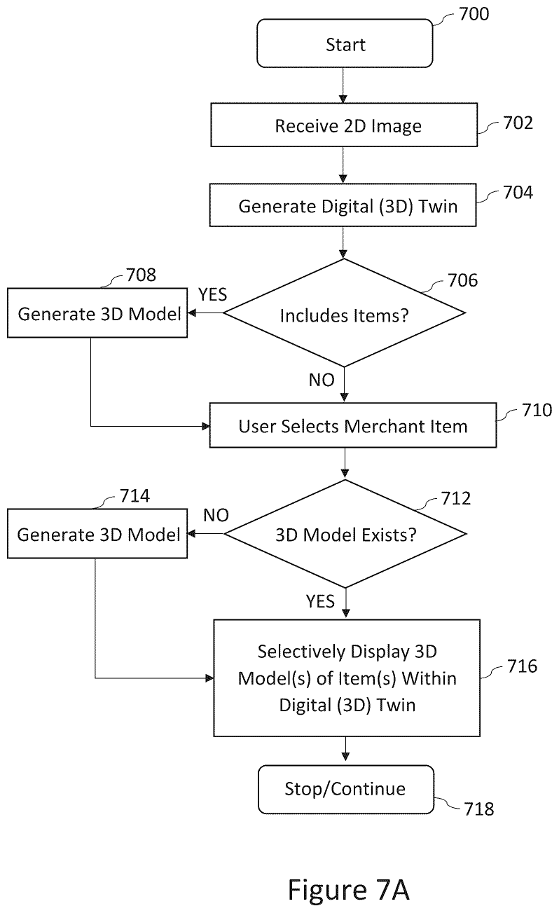

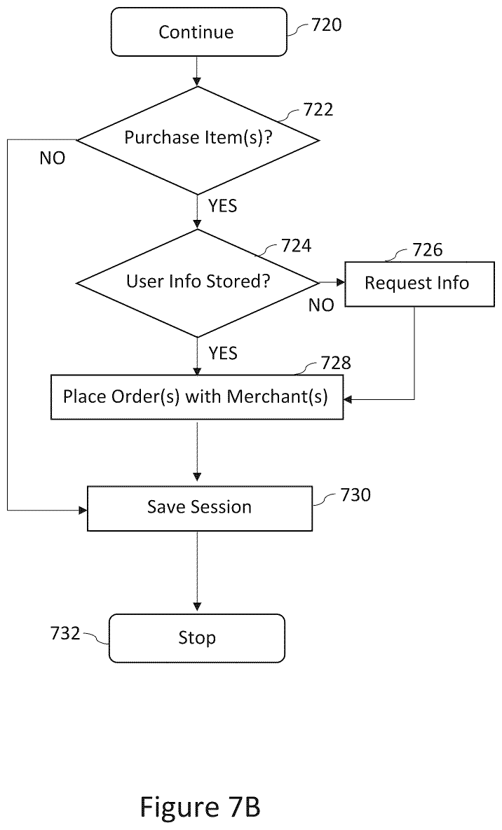

A method for providing interactive visualization of retail items is shown in FIG. 7A, starting at step 700, where a digital twin is created, items available for sale by merchants are selected, and virtually presented within (or along with) the digital twin. For example, a user may start by uploading an image (or a photo) of their room at step 702. See, e.g., FIG. 2 at 200. A 3D representation (or digital twin) of the room can then be created at step 704. See, e.g., FIG. 2 at 300. The digital twin may then be analyzed to determine if there are items located within the room (or space) at step 706. If there are, then a digital model of each item is created at step 708. These items can then either be left in the room or removed (e.g., decluttering the room), where the item is either deleted or made available for future placement within the digital twin. In one embodiment, the user that decides which items are modeled, deleted, etc. In other embodiments it is a “decluttering” algorithm that makes these decisions automatically.

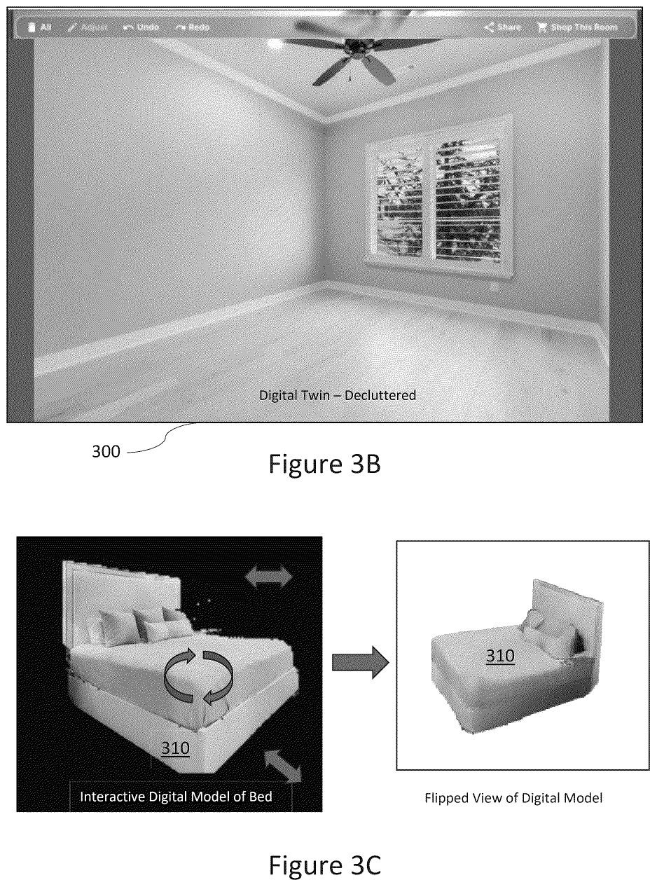

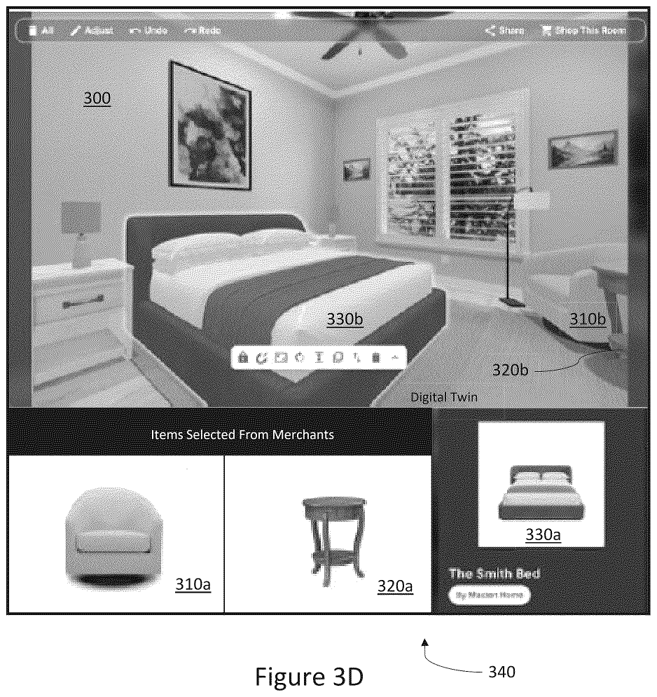

For the items that are left in or made available for future placement, a 3D representation (or model) of the item may be created (step 708), and the user may be allowed to interact with them (e.g., rotate them, move them to another location within the digital twin, etc.). This can be seen, for example in FIGS. 3A and 3C where a bed 310 within the digital twin 300 is identified, digitally modeled, and is interactable (e.g., can be rotated, moved, flipped, etc.).

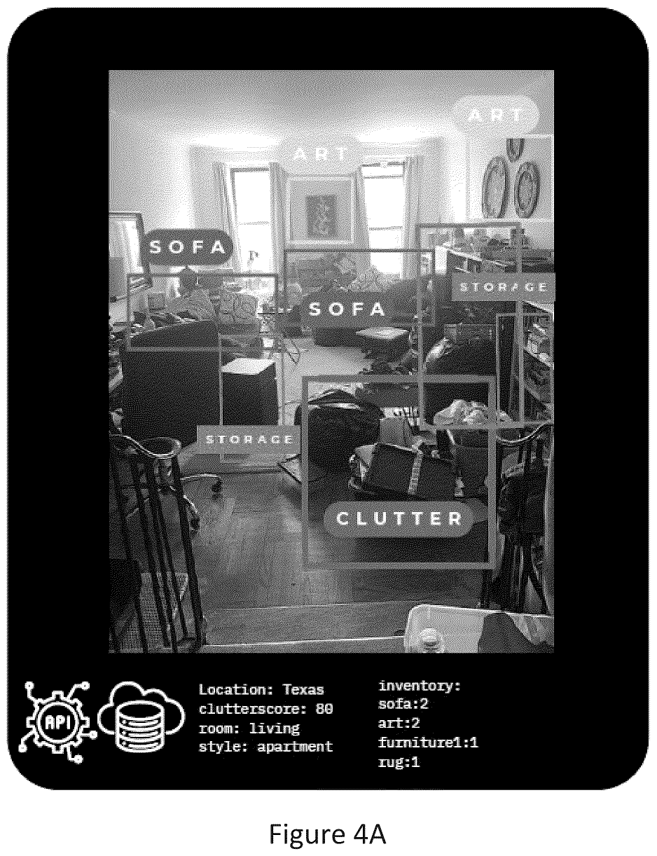

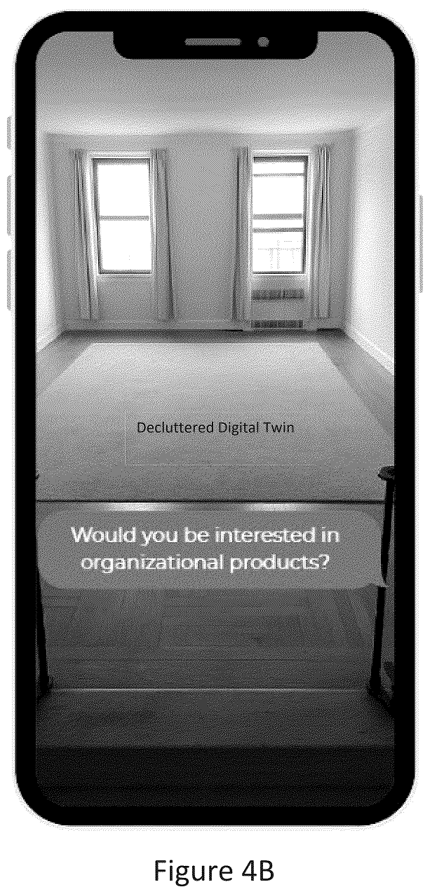

Alternatively, items can be removed from the digital twin, thereby decluttering the room. See, e.g., FIG. 3B. In one embodiment, as shown in FIG. 4A and B, the “decluttering” algorithm or application (see FIG. 1 at 14 and/or 16) analyzes the digital twin and “segments” individual items depicted therein. In one embodiment, segmentation further includes object detection and categorization (e.g., sofa, storage, clutter, etc.). The application can then determine (e.g., based on its classification) whether certain items should be removed (e.g., clutter, etc.) or 3D modeled for future use (e.g., sofa, storage, etc.). Either way, the digital twin can then be decluttered (see FIG. 4B) with items modeled made available for user insertion and/or manipulation. The inventory of items can also be used (e.g., by the host's application) to make judgments on the style, age, and potential price of items and provide suggestions to the user on similar or compatible items that are for sale. For example, if an item is rustic, the application may suggest rustic items that are for sale. Similarly, if an item is identified as old, damaged, or outdated (e.g., compared to other items, etc.), the application may suggest suitable replacement items that are for sale.

With reference to FIG. 7A, the user can then shop and select items that are for sale from various merchants at step 710. In some instances, the host has previously received information about certain items (e.g., image, price, options, etc.) and created 3D models of the items (e.g., by converting 2D images into 3D models). However, in other instances, such information will have to be retrieved (e.g., in real time) and a digital model created (see steps 712, 714). Either way individual items are selectively displayed within the digital twin in step 716, where the items and the digital twin are interactive (e.g., the user can move the items within the space, the user can change their perspective within the space, etc.).

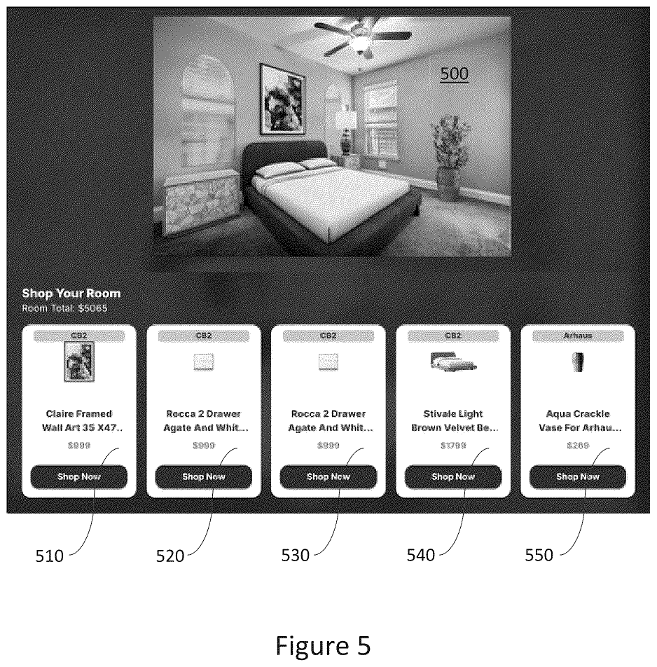

This can be seen, for example, in FIG. 3D where the user has selected a first item (chair) 310a, a second item (table) 320a, and third item (bed) 330a from one or more merchants. These items may be shown in a preview pane 340, with 3D digital models of the same (310b, 320b, 330c) shown in the digital twin 300. Similar features can be seen in FIG. 5, with images of selected items 510, 520, 530, 540, and 550 shown in a preview pane and digital models of the same shown in the digital twin 500.

It should be appreciated that the present invention is not limited to the steps identified in FIG. 7A, and fewer, additional, and/or different steps are within the spirit and scope of the present invention. For example, the digital twin may be provided to the host or created from user provided data (other than a photo). By way of another example, selecting items available from different merchants (or browsing for items) may involve searching for items by type, manufacturer, merchant, size, color, texture, style, genre or any other searchable feature generally known to those skilled in the art. The search parameters may be applied to a plurality of items available in the host's database and/or on external databases (e.g., merchants' databases). By way of yet another example, the user may be able to view items for sale from different merchants together with items that the user currently owns (e.g., items depicted in the user's space, photos of items provided by the user, etc.).

With respect to the foregoing, creating the user's space may involve (a) initial data capture, which may involve acquiring one or more images, videos, LiDAR scans, photogrammetry datasets, or other spatial data sources of the user's physical environment (e.g., home, office, construction site, etc.), (b) capturing spacial metadata, such as lighting conditions, surface materials, color profiles, and room dimensions, and (c) a decluttering process, which employs an algorithm to remove or mask existing furnishings or objects from the acquired data if the user wishes to visualize the space in a more “empty” or simplified state.

A digital twin of the user's space can then be created (or imported if already available). This may involve (a) 3D reconstruction, or converting the captured spatial data into a 3D model using photogrammetry, structured light scanning, depth sensing, or a machine-learning-based 2D-to-3D conversion pipeline, (b) a mesh and texturing process, which may include processing and optimizing the resulting 3D mesh by reducing polygon count, correcting geometry, and applying textures derived from the original data or synthetic textures, (c) spatial calibration, or calibrating the 3D model for real-world scale and orientation (e.g., aligning floor planes, walls, and ceilings and ensuring accurate measurements for item placement), and (d) storage and retrieval of the resulting digital twin in a secure server, cloud-based environment, or local device memory for subsequent retrieval and visualization.

The user may then be provided with access to retail choices via a backend database. This may include (a) retail integration, or aggregating a plurality of retail catalogs from different vendors or partners into a unified data stream or database, (b) item classification (with metadata) for each retail item, including store relevant attributes such as brand, dimensions, color, style, price, availability, shipping options, and 3D model or AR-compatible assets, and (c) search and/or filtering mechanisms, which provide the user with search, sort, and filtering capabilities (e.g., by style, color, price range) to efficiently browse items from multiple retailers.

An interactive placement engine may then be used in the (a) selection of items, which may enable the user to browse, preview, and select desired items from the aggregated catalog, (b) item preview of selected items, which may involve retrieving the corresponding 3D asset from the server or local cache to prepare it for placement in the user's digital twin, (c) placement interface, which presents an intuitive interface (e.g., drag-and-drop, touchscreen gestures, mouse-based interactions) that allows the user to position the selected item within the 3D environment, and (d) collision and spatial awareness, which incorporates collision detection or real-world dimension checks to prevent items from intersecting walls or other objects in the digital twin.

A visualization engine (e.g., application) can then be used for rendering the digital twin with the selected items. This may include (a) real-time (or near real-time) rendering of the digital twin with the selected items, optionally using advanced graphics techniques such as ray tracing, global illumination, or physically based rendering for enhanced realism, (b) lighting and shadows, which simulates or approximates lighting conditions in the user's space to display realistic shadows and reflections of the placed items, and (c) material simulation, which allows the user to adjust or experiment with material finishes (e.g., floor textures, paint colors) to see how the item's appearance changes under different conditions.

The user may then be presented with tools to manipulate placement, scale, and/or orientation. This may include (a) transform controls, providing the user with UI elements (e.g., rotation handles, scale sliders, or numeric input fields) to manipulate the item's position, orientation, and scale, (b) constraint enforcement to maintain realistic proportions (e.g., lock aspect ratios or limit scaling to real-world dimensions) or to snap items to certain angles or surfaces, and (c) undo/redo functionality, to allow the user to revert or restore previous states of item placement, orientation, or scale adjustments.

In one embodiment of the present invention, the user can select more than one item from more than one merchant. As such, the user may be able to add, remove, or rearrange several items from different retailers in the same digital twin environment. The user may also be provided with scene saving and versioning functionality, providing the capability to save different configurations or “scenes,” allowing the user to compare multiple layout options, and collaborative editing, allowing multiple users (e.g., family members, co-workers) to view or modify the same digital twin, either synchronously or asynchronously.

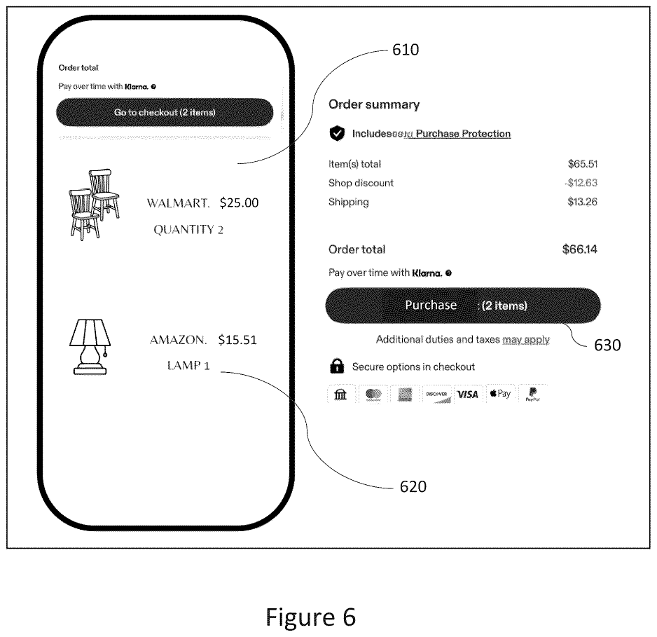

After virtual visualization, the user is provided with the option to purchase items that have been visualized. This can be seen, for example, in FIG. 6 where a first item 610 is from a first merchant and a second item 620 is from a third merchant. The user can then interact with a single “purchase” button 630 (or the like) to effectuate the transaction, which may involve purchasing different items from different merchants. This may involve (a) item consolidation, which gathers the selected items in a virtual shopping cart or aggregated list, even if items originate from multiple merchants, (b) price and availability updates, by retrieving the latest pricing and availability data from each retailer's system, ensuring the user has real-time or near real-time information, (c) integrated or redirected checkout, which provides a unified checkout process within the application or seamlessly redirect the user to the respective retailer's platform for payment, shipping, and order confirmation, and (d) order tracking and confirmation (e.g., delivery dates, etc.) within the same interface. In one embodiment, the unified checkout system (e.g., application) may allow the user to enter payment and shipping information once, even when multiple items are purchased from multiple merchants.

The “unified checkout” method is shown in FIG. 7B, starting at 720. If the user is only viewing selected items and not purchasing, the user's session (e.g., 3D models of selected items presented on the user's digital twin) may be saved for later use at step 730. If the user is purchasing at least one item at step 722, then the system must determine where user information (e.g., name, shipping address, financial data, address linked to financial data, etc.) was previously stored at step 724. This may be the case if the user has an account with the host and logged in prior to participating in the method outlined in FIG. 7A. If not, then user information is requested and/or retrieved from the user at step 726. The system (or an application operating thereon) then places the order at step 728, which may involve using the user's information (see, e.g., steps 724 and 726) to place individual orders with individual merchants. The session is then preferably saved at step 730, ending the method at step 732.

It should be appreciated that the present invention is not limited to the steps recited in FIG. 7B and may involve additional, fewer, and/or different steps. For example, instead of the unified checkout process at step 728, the system may redirect the user to individual merchants, where such information is then provided (e.g., by the user manually or by the system automatically). By way of another example, if the user has an account with one or more of the merchants, then the host may use user's login data (e.g., instead of the user information identified in steps 724 and 726) to place the order with one or more merchant, with the understanding that the user may have different login data for different merchants.

In other embodiments of the present invention, the system may also provide different analytics and/or recommendations, including (a) user preference profiling, which tracks user interactions such as favored styles, frequently placed items, or color preferences to inform recommendation algorithms, (b) contextual suggestions, such as item suggestions or complementary items based on the user's existing layout, color schemes, or budget preferences, and (c) retail feedback, which sends aggregated, anonymized data to participating retailers to optimize inventory, marketing, or product development strategies.

The system may also provide multi-platform accessibility, such as (a) device-agnostic deployment, where the system is accessible on various devices, including mobile phones, tablets, desktop computers, or VR/AR headsets, and (b) cross-platform synchronization to maintain a synchronized user profile and 3D environment state across multiple platforms, enabling the user to continue designing or shopping from any device. Security and data privacy measures may also be put in place, including (a) user authentication (e.g., login or identity verification to prevent unauthorized access to personal 3D models or purchase data), (b) encrypted data transmission to ensure that all spatial data, item metadata, and transaction details are transmitted via secure, encrypted channels, and (c) privacy controls or settings (e.g., to limit data sharing with third parties or retailers, ensuring compliance with relevant privacy regulations).

Optional services that may be provide include (a) profession consultation, such as offering direct links to interior designers, contractors, or specialists who can advise on best practices for real-world installation, (b) augmented reality mode (e.g., enabling an AR overlay to selected items into the user's physical environment in real-time for final confirmation), and (c) maintenance and care guidance (e.g., tips, warranty information, cleaning instruction, or recommended accessories).

Other features of the present invention may include (a) a decluttering process, or an Al-based declutter feature that automatically detects and removes furniture from the captured images, allowing users to visualize items in a “clean slate” version of their space, (d) data integration, allowing the system to integrate with third-party APIs or retailer databases to retrieve up-to-date product information, availability, and pricing, (c) user interface (UI) customization, where the platform may employ different UI layouts depending on whether it is accessed via a mobile device, desktop application, or in-store kiosk, (d) payment gateway options, where payment may be processed through a universal checkout system or individually through each retailer's e-commerce platform, (e) analytics and machine learning, where machine learning models may be used to enhance item recommendations, improve 3D reconstruction, or provide intelligent placement suggestions (e.g., “snap-to-grid,” recommended spacing), and (f) real-time collaboration with others, where each user's actions are visible to the other participants via networked sessions.

Many of the foregoing features are from the system's vantage point, where certain features and functions are carried out “behind the scenes,” without direct user knowledge or involvement. From a user's standpoint, however, the system should be user-friendly and relatively straight forward, aiding the user with visualizing and purchasing items from third-party merchants, manufactures, or suppliers. For example, multiple items may be selected, visualized, and purchased from a single merchant (e.g., Amazon), where each item is sourced from different manufactures or suppliers, or multiple items may be selected, visualized, and purchased from different merchants (e.g., one item from Amazon and one from Wayfair).

From the user's vantage point, the user may want to redesign, design, or organize a personalized space. Traditionally the user is required to use traditional catalogue type marketplaces in which they need to search for items and add items into a cart (individually). The present invention can tie together any retailer and present the retail assets in the user's personal 3D space, including but not limited to indoor, outdoor, commercial, residential, construction, or automotive, shipping or air.

The user may begin their shopping experience by logging on to a particular website and adding a virtual space to their account, which involves uploading a single 2D photo, or a sequence of photos, of their space. The system may then transform the 2D image into a 3D scene. A 360-degree photo can also be uploaded for a fully immersive space. Alternatively, the user can upload a manually created 3D scene or a virtual tour, where the digital twin is created using 3D tools made available via the website or other 3D rendering software. Other 3D modeling is also within the spirit and scope of the present invention.

For example, 3D scanning technologies like structured light scanning, time-of-flight cameras, or photogrammetry can be used to capture a 3D model of the user's physical space. This may involve the user scanning their room, home, or other environment using a dedicated 3D scanner or even a smartphone app. The scanned data would then be processed to create a detailed 3D digital twin model. In another embodiment, augmented reality (AR) or virtual reality (VR) headsets and controllers to allow the user to map out a user's physical space. The user could then “walk through” their environment while the system tracks their movements and builds a 3D model. This could be done through a dedicated application or by integrating with existing AR/VR platforms. Manual 3D modeling could also be used, where the user is provided with 3D modeling tools to manually create a digital twin of their space. This may involve the user measuring their environment and then building a 3D model using CAD or 3D modeling software. While more time-consuming, this approach allows for precise control over the digital twin. Lastly, a hybrid approach can be used, combining automated 3D scanning with manual modeling refinements. In this embodiment, the initial 3D scan is used as a base, where further edits and enhancements are made by the user to the model to match their space. The optimal approach would depend on factors like cost, user experience, accuracy requirements, and the target platform (e.g. web, mobile, AR/VR). A hybrid solution that balances automation and user control could provide the best overall experience.

If the user has a space that requires decluttering or the user desires to remove certain items from the scene, the application may allow the user to declutter/remove items from their space. This may be accomplished using (a) inpainting tools to select furniture or items for removal which can be sent to Al for removal or (b) image segmentation, where items are segmented by clutter (furniture versus structural material) and the system automatically generates an empty version of the space. It should also be appreciated that instead of removing an item, a digital twin of the item can be created, allowing the user to interact with digital twin items at the same time retail items are being visualized. The digital twin items (e.g., the user's existing couch, coffee table, etc.) may also be removed and made available in the scene inventory, so that it can be added back into the scene later if desired.

In other words, a process referred to as “assetization of the space” may be performed where the scene photo is sent through image segmentation where every item and structural object is detected and outlined in the scene. The items may then be added to the scene inventory for later usage. Individual items from the inventory are fed into a 3D model creator in which 3D model assets are created for each item in the scene. These model assets may then be used in the scene, moved throughout the user's account, or shared with others. Asset lookup can ping several computer vision APIs to get the most probable value of the current assets within the scene. This data may be stored in a database associated with the location and demographic data of the scene and user.

Once a user has their space and models, the scene will load up for the user as a shopping experience. The user may then be able to select items from different merchants. Images of the items are then acquired from either the system's database or the merchant (e.g., via a link). The user can either select their items or use automated furniture placement, in which the application's Al will decide furniture placement and pieces that go together within the scene.

For instance, automatic furniture placement can pull items from several merchants (e.g., living room items that are all the same style and price range along with any other preferences indicated by the user or assumed by the application). The system may determine using a set of heuristics to decide the optimal placement. The user may then pick and choose from any item in the system or visualized and drag and drop furniture throughout their space. Since models of individual items will be created for the user's current space (e.g., their existing bed, chair, etc.), the user can rearrange their space without having to lift furniture or anything. A user can replace specific items in the scene and/or select items from anything that is not in the system (e.g., by adding a URL of the image or uploading the image so that the system can create a 3D model of the item). If the user only has a photo of the item, they may also feed that into the system, where a 3D model is created.

Such a system not only allows the user to view items for sale by different merchants (or 3D representations of those items), but to do so in a 3D representation of their own space, with their existing items. The user can then interact with the items (both their own and for sale) to move them to different locations within the room, adjust their scale and/or orientation, change color, texture, etc. For example, the user may be provided with intuitive controls to translate, rotate, and scale the placed retail items within the digital twin space. The user may also be able to add annotations, labels, or other visual cues to the placed products or the digital twin environment. The user may also be provided with intuitive camera controls to explore the digital twin from different perspectives, allowing the user to pan, zoom, and rotate the view to inspect the placed products from various angles. The items may also be presented with overlay informative annotations, such as product details, pricing, and availability, enabling the user to interact with the placed products, triggering additional information or actions.

The user is then offered the option of purchasing any item that is visualized. This can be accomplished via a unified checkout system, where a universal cart that is integrated with each individual merchant's POS is used to effectual purchasing and shipping items. Unified checkout may also provide the user with a total for items visualized, renovation links to get contractors, a save-for-later feature, financing, Facebook marketplace data for historic items, etc.

The present invention offers several advantages, including (a) enhanced visualization of retail items in a user's space, (b) improved purchasing decisions through interactive experience, (c) bridging the gap between online and offline shopping, (d) increased buyer confidence and reduced uncertainty, and (e) valuable tools for retailers to showcase products and increase sales.

Commercial opportunities include the ability to visualize multiple items from multiple retailers simultaneously within a realistic 3D environment, which represents a substantial improvement over existing technologies. This creates a strong competitive advantage and opens significant commercial opportunities across various sectors of the home goods and design industries. The system's scalability and adaptability to different platforms and applications further enhance its market potential.

Key commercial opportunities include (a) enhanced e-commerce platforms, which integration with existing e-commerce platforms that allow customers to virtually place items in their homes before purchase, significantly reducing purchase uncertainty and return rates, which translates to increased sales conversions and reduced operational costs for online retailers, (b) in-store design studios by providing customers with an immersive experience to visualize furniture, decor, and other home goods within their own space, which enhances customer engagement, improves sales conversion rates, and differentiates retailers from competitors, (c) interior design software, where the system is integrated into existing interior design software, providing designers and clients with a powerful tool for visualizing and planning projects, which improves collaboration, reduces design errors, and enhances client satisfaction, (d) home improvement retailers can use this technology to showcase products in a customer's home, allowing them to visualize how different materials, colors, and fixtures would look in their space, which can increases sales and reduces customer uncertainty, and (e) licensing opportunities in related industries, generating recurring revenue streams.

In sum, the invention presents a novel approach to interactive retail visualization, offering a significant advancement over existing technologies. The ability to simultaneously visualize multiple products from multiple merchants within a photorealistic 3D environment of the user's space creates a “try-before-you-buy” experience. This enhances customer engagement, improves purchasing decisions, and bridges the gap between online and offline shopping. The visualization capabilities enhance the shopping experience by allowing consumers to assess the product's fit, scale, and aesthetic within their specific environment, thereby reducing uncertainty and increasing buyer confidence. This not only benefits consumers but also provides retailers with a valuable tool to showcase their products and increase sales.

Having thus described preferred embodiments for a system and method for interactive visualization of retail items in a user “digital twin” space, it should be apparent to those skilled in the art that certain advantages have been achieved. It should also be appreciated that various modifications, adaptations, and alternative embodiments thereof may be made within the scope and spirit of the present invention. For example, those skilled in the art will appreciate that there are a number of ways to implement the foregoing features, and that the present invention it not limited to any particular way of implementing these features. The invention is solely defined by the following claims.

1. A system for interactively visualizing at least one retail item for sale from at least one merchant within a three-dimensional (3D) visual representation of a user-provided space, comprising:
a host in communication with a user and a plurality of merchants via a wide area network (WAN), said host comprising at least one memory device for storing machine readable instructions adapted to perform the steps of:
receiving a two-dimensional (2D) image of said user-provided space from said user, said user-provided space including at least a floor portion and at least one wall portion, wherein at least one user item is located on either said wall portion or said floor portion;
using said 2D image to generate (a) said 3D visual representation of said user-provided space including said floor portion and said at least one wall portion and (b) a 3D visual representation of said user item;
allowing said user to select said retail item for sale from said merchant, wherein said retail item has an associated image from which a 3D visual representation has been created; and
presenting to said user said 3D visual representation of said retail item within said 3D visual representation of said user-provided space wherein said user can selectively move said 3D visual representation of said retail item within said 3D visual representation of said user-provided space and selectively insert, remove, and move said 3D visual representation of said user item within said 3D visual representation.

2. The system of claim 1, wherein a plurality of user items are located on either said wall portion or said floor portion of said user-provided space and said machine readable instructions are further adapted to automatically declutter said user-provided space by presenting only a portion said plurality of said user items within said 3D visual representation of said user-provided space.

3. The system of claim 2, wherein said decluttering involves object detection and categorization, wherein only certain categories of said plurality of user items are presented within said 3D visual representation of said user-provided space.

4. The system of claim 2, wherein said decluttering requires said user to identify which ones of said plurality of user items are to be removed from said user-provided space and which ones of said plurality of user items are to be 3D modeled for presentation within said 3D visual representation of said user-provided space.

5. The system of claim 1, wherein said user is allowed to browse through a plurality of retail items for sale from a plurality of merchants on said host's website where each one of said plurality of retail items has a corresponding 3D visual representation that was previously generated by said host.

6. The system of claim 5, wherein said machine readable instructions are further adapted to select said plurality of items from a database of items based on at least one attribute of said user item.

7. The system of claim 1, wherein said user is allowed to select said retail item from a website operated by said merchant.

8. The system of claim 7, wherein said machine readable instructions are further adapted to generate said 3D visual representation of said retail item from at least one 2D image of said retail item made available by said merchant.

9. The system of claim 1, wherein said machine readable instructions are further adapted to allow said user to select a first retail item for sale from a first merchant and a second retail item for sale from a second merchant and to present 3D visual representations of both said first and second retail items within said 3D visual representation of said user-provided space.

10. The system of claim 9, wherein said machine readable instructions are further adapted to receive a single purchase request from said user, said single purchase request resulting in said host purchasing for said user said first item from said first merchant and said second item from said second merchant.

11. The system of claim 1, wherein said machine readable instructions are further adapted to present said retail item in a preview pane along with information on said retail item.

12. The system of claim 11, wherein said information on said retail item includes options that can be selected by said user, said selected options being incorporated into said 3D visual representation of said retail item within said 3D visual representation of said user-provided space.

13. The system of claim 12, wherein said options includes at least one of a plurality of colors and a plurality of textures.

14. A method for interactively visualizing at least one retail item for sale from at least one merchant within a three-dimensional (3D) visual representation of a user-provided space, comprising:
receiving by a host a two-dimensional (2D) image of said user-provided space from said user, said user-provided space including at least a floor portion and at least one wall portion, wherein at least one user item is located on either said wall portion or said floor portion;
using by said host said 2D image to generate (a) said 3D visual representation of said user-provided space including said floor portion and said at least one wall portion and (b) a 3D visual representation of said user item;
selecting by said user said retail item for sale from said merchant, wherein said retail item has an associated image from which a 3D visual representation has been created; and
presenting by said host to said user said 3D visual representation of said retail item within said 3D visual representation of said user-provided space wherein said user can selectively move said 3D visual representation of said retail item within said 3D visual representation of said user-provided space and selectively insert, remove, and move said 3D visual representation of said user item within said 3D visual representation.

15. The method of claim 14, further comprising the step of presenting to said user a plurality of retail items for sale from a plurality of merchants wherein said plurality of items were previously stored in a host database along with corresponding 3D visual representations of the same.

16. The method of claim 14, further comprising the step of allowing said user to select said retail item from a website operated by said merchant, wherein said 3D visual representation of said retail item is generated from at least one 2D image of said retail item made available by said merchant.

17. The method of claim 14, wherein said step of selecting said retail item from said merchant further comprises selecting a first retail item for sale from a first merchant and a second retail item for sale from a second merchant, said host presenting 3D visual representations of both said first and second retail items within said 3D visual representation of said user-provided space.

18. The method of claim 17, further comprising the step of receiving a purchase request from said user, said request resulting in said host purchasing for said user said first item from said first merchant and said second item from said second merchant.

19. The method of claim 14, further comprising the step of presenting a 2D version of said retail item in a preview pane along with information on said retail item, said information including at least one option for said retail item that can be selected by said user.

20. The method of claim 19, further comprising the step of incorporating said selected option into said 3D visual representation of said retail item within said 3D visual representation of said user-provided space.
